(19) United States
(12) Patent Application Publication
(10) Pub. No.: US 2012/0260503 A1
(43) Pub. Date: Oct. 18, 2012

(54) Method of Manufacture for a Universal Offset Connecting Rod for Internal Combustion Engine

(76) Inventor: Val Licht, Stetsonville, WI (US)

(21) Appl. No.: 13/536,680

(22) Filed: Jun. 28, 2012

Related U.S. Application Data
(63) Continuation-in-part of application No. 12/465,318, filed on May 13, 2009.

(51) Int. Cl. B23P 15/00; B21D 53/84

(52) U.S. Cl. 29/888.091; 29/888.09; 29/888.092

(57) ABSTRACT

A universal offset connecting rod and method of manufacture of a universal offset connecting rod comprised of an offset connecting rod having an offset longitudinal axis, a first circular aperture used for pivotally attaching the offset connecting rod to a wrist pin, and a second circular aperture used to pivotally attach said offset connecting rod to a crankshaft, and a force transfer area creating an angle of offset which directs the line of action to a point away from the center of said second circular aperture. The force transfer area is a triangular area free from any solid material and defined by the normal line of action on one side and the offset connecting rod on the remaining two sides. The connecting rod is therefore discontinuous along the traditional line of action, resulting in a completely offset of transferred force.

### CROSS-REFERENCE TO RELATED APPLICATIONS

This application is a continuation-in-part and claims priority to U.S. Non-provisional Application No. 12/465,318 filed on May 13, 2009.

### FIELD OF INVENTION

The present invention relates generally to the field of internal combustion engines, and in particular to a connecting rod.

### BRIEF DESCRIPTION OF THE DRAWINGS

FIG. 1 shows a side perspective view of a traditional connecting rod.

FIG. 2 shows a side perspective view of the universal offset connecting rod.

FIG. 3 shows a side perspective view of the one embodiment of a universal offset connecting rod, further showing the universal offset connecting rod within an internal combustion engine at top dead center.

### GLOSSARY

As used herein, the term “force transfer area” shall refer to a physical gap, void or open area (including curvature and contouring) that eliminates the traditional line of action found in a conventional connecting rod and redirects the force to an offset line of action.

As used herein, the term “force transfer area equation” shall refer to the following equation:

(½)((0.1)(w))(((0.1)(w))(cotθ))

In this equation, w is defined as the traditional line of action. θ is defined as the calculated angle of offset. It is critical that a force transfer area, as calculated using the force transfer area equation, be greater than zero and less than 45 degrees.

As used herein, the term “traditional line of action” is a line of action running from the center point of the wrist pin to the center point of the big end bearing.

As used herein, the term “offset line of action” is a line of action running from the center point of the wrist pin to away from the center of big end bearing and is the result of including a force transfer area in a connecting rod.

As used herein, the term “connecting rod” shall refer to any element or system that connects the piston to the crankshaft using the wrist pin at the piston end, and the big end bearing at the crankshaft end.

As used herein, the term “angle of offset” shall refer to the angle between the traditional line of action and the offset line of action. As used herein, it is critical that the angle of offset be greater than 0 and less than 45 degrees.

As used herein, the term “angle of offset equation” shall refer to the following equation:

θ=arcsine(r/L)

In this equation, L is defined as the distance between the center point of the wrist pin aperture and the center point of the big end bearing aperture. r is defined as the measure of the radius of the big end bearing aperture. θ is defined as the calculated angle of offset.

As used herein, the term “universal” means an apparatus which may be adapted for use in any internal combustion engine using the force transfer area equation and angle of offset equation.

As used herein, the term “force transfer angle” means the angle of offset formed between the offset line of action of the offset connecting rod and the traditional line of action of a traditional connecting rod.

As used herein, the term “offset longitudinal axis” refers to the axis of the elongated body of the offset connecting rod.

As used herein, the term “line of action” means the path along which the force of an action is transferred.

As used herein, the term “co-linear” means a force that acts in the same line as the line extending through the center point of the wrist pin aperture 122 and the center point of the big end bearing aperture 132.

As used herein, the term “circular” means in the shape of a circle which is substantially circular and does not require that a perfect circle be formed.

### BACKGROUND

In the present art, an internal combustion engine is comprised of at least one cylinder containing a piston connected to a crankshaft through the use of a connecting rod. The pistons in a typical internal combustion engine move in a linear manner within the cylinders of the engine. In a traditional combustion engine, the connecting rod allows the linear force created by a piston to be transmitted through the body of the connecting rod to a big end bearing, and ultimately to the rotating crankshaft. The crankshaft rotates within the engine and transfers power from the engine.

When ignition occurs within the cylinder, the burning fuel/air mixture expands and the piston is driven toward the crankshaft. The force of the expanding mixture is transferred through the piston, to the wrist pin and through the body of the connecting rod to the big end bearing, and ultimately to the crankshaft. This is accomplished by a mechanical linkage of the components and a force transmitted through the connecting rod that is co-linear to the center line of the crankshaft. With respect to a connecting rod, a co-linear force is inherently inefficient as compared to a torque (offset) force. There have been many attempts in the prior art to create a torque force which would replace the co-linear force of the connecting rod, and create a predictable scientific result based on Newton's laws which predict the resulting force from co-linear versus torque force and the desirability of creating a force perpendicular to the crankshaft.

Various attempts have been made to develop an internal combustion engine which uses a connecting rod to produce a torque force rather than a co-linear force to increase the power and efficiency of the engine. For example, U.S. Pat. No. 5,460,505 (the '505 patent) discloses an engine which incorporates an “offset connecting” rod. However, this disclosure fails to enable a functioning offset connecting rod and allow use of the device in an existing combustion engine as for manufacturing a working embodiment of an offset connection rod.. While the '505 patent discloses the desirability of using an offset connecting rod, neither the figures included within the patent nor the written description include enabling data to create a working embodiment of an offset connecting rod.

It is known in the art that, as the inventors of the '505 patent claim on their website “[t]he principle of leverage can also be derived using Newton's laws of motion and modern statics.” Upon a reading of the '505 patent it is thus apparent that its drafters have identified a scientific principal of leverage, but have not enabled a specific working embodiment of an apparatus which can be manufactured to implement the generalized scientific principle.

It is therefore desirable to identify a structural configuration that will provide a working embodiment of an offset connecting rod and to provide an enabling disclosure of the calculations which must be performed to create a proven method of manufacture to replicate the working embodiment of the general non-enabling concept disclosed in the '505 patent.

Further, the connecting rod of the '505 patent does not completely eliminate co-linear force to produce complete torque force. When the connecting rod of the '505 patent is in its top dead center position, or with the piston at the top of the cylinder, the traditional line of action still occurs completely along the connecting rod.

It is therefore desirable to identify a structural configuration that will provide a working embodiment of an offset connecting rod that eliminates co-linear force and produces complete torque force.

### SUMMARY OF THE INVENTION

The present invention is a method of manufacturing a universal offset connecting rod comprised of an elongated body having an offset longitudinal axis, a first circular aperture and a second circular aperture. The first circular aperture attaching the offset connecting rod to the wrist pin and the second circular aperture connecting the offset connecting rod to the big end bearing. The offset longitudinal axis of the elongated body of the rod has an angle of offset which creates an open area, free from any solid material, redirecting the line of action away from the center point of the aperture of the big end bearing and the traditional line of action. As a result, there is a complete discontinuity in the offset connecting rod along the traditional line of action, resulting in a complete offset of force transfer.

### DETAILED DESCRIPTION OF INVENTION

For the purpose of promoting an understanding of the present invention, references are made in the text hereof to embodiments of a universal offset connecting rod, only some of which are described herein. It should nevertheless be understood that no limitations on the scope of the invention are thereby intended. One of ordinary skill in the art will readily appreciate that modifications such as the dimensions of the connecting rod, alternate but functionally similar material(s) from which the connecting rod is made, and the inclusion of additional elements are deemed readily apparent and obvious to one of ordinary skill in the art, and all equivalent relationships to those described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

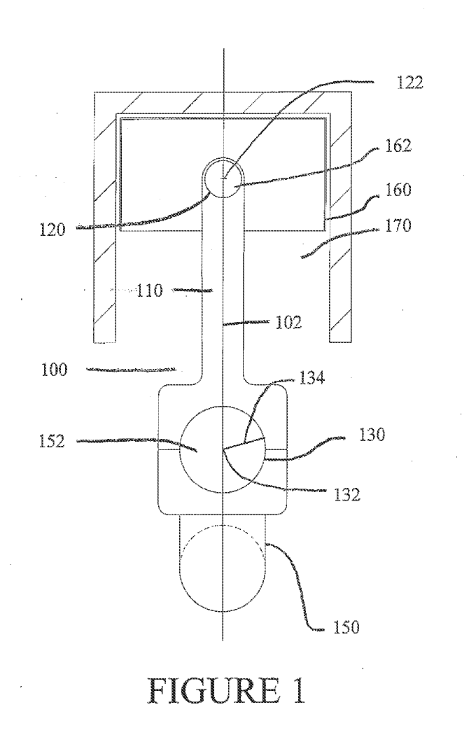

Referring now to the drawings, FIG. 1 is a side perspective view of a traditional connection rod 100 at top dead center position which shows traditional line of action 102. The traditional connecting rod 100 is fitted within cylinder 170 and is connected to piston 160 through wrist pin 162. The traditional connecting rod 100 then connects to crankshaft 150 through the big end bearing 152. The traditional connecting rod 100 has an elongated rod body 110 co-linear to the traditional line of action 102 extending between wrist pin aperture 120 and big end bearing aperture 130. The wrist pin aperture having a center point 122 and the big end bearing aperture having a center point 132 and radius 134.

In order to eliminate co-linear force, a connecting rod body must be off-set so that the force indicated by the traditional line of action 102 leaves the plane of the connecting rod.

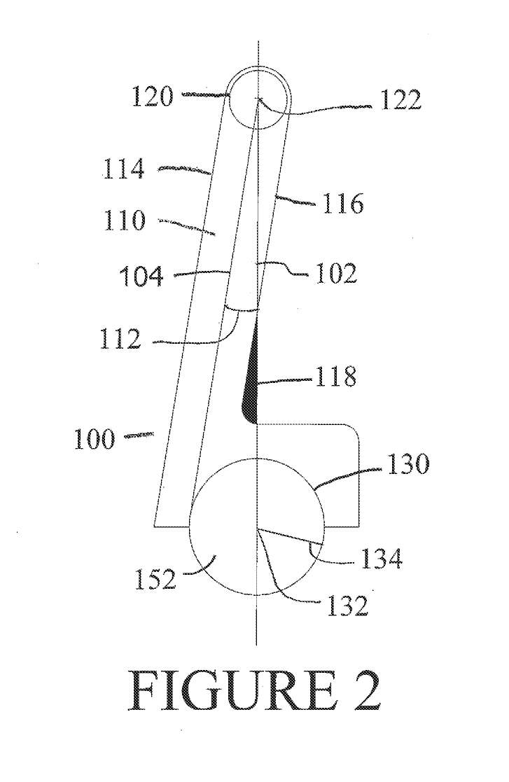

FIG. 2 shows a side view of one (1) embodiment of offset connecting rod 100. Offset connecting rod 100 contains an elongated rod body 110 extending between wrist pin aperture 120 and big end bearing aperture 130. Wrist pin aperture 120 having a center point 122. Big end bearing aperture 130 having a center point 132 and radius 134. Elongated rod body 110 further includes an outer edge 114, an inner edge 116 and an offset line of action 104. Also shown in FIG. 2 is angle of offset 112, which is the angle formed between traditional line of action 102 and offset line of action 104.

Unlike offset rods of the prior art, a line extended from inner edge 116 will not intersect big end aperture 130 at traditional line of action 102, but rather between traditional line of action 102 and offset line of action 104.

FIG. 2 further shows a force transfer area 118 which is a gap or lack of continuity in the material from which elongated rod body 110 is constructed, and which eliminates the traditional line of action found in a conventional connecting rod. Force transfer area 118 redirects the force to an offset line of action 104 created by angle of offset 112 between the line of action in traditional connecting rod and offset connecting rod described herein. In various embodiments, force transfer area 118 may be created by the removal of metal, contouring, milling, molding, forging curvature, an aperture, remanufacturing or by any other structural configuration.

The structural lack of continuity in material along traditional line of action 102 is critical, as it results in a portion of the traditional line of action 102 occurring outside of elongated rod body 110. Force cannot transfer through a gap or void. As a result, force transferred along connecting rod 100 will be entirely offset from traditional line of action 102. Without creating a void or complete discontinuity in material along traditional line of action 102, force will still transfer along that traditional line of action 102.

The embodiment of offset connecting rod 100 shown in FIG. 2 may be made universal by a method of manufacture disclosed herein which uses the force transfer area equation, where the force transfer area is always greater than 0, and the angle of offset equation.

The force transfer area equation is (½)((0.1)(w))(((0.1)(w))(cotθ)), where w is the radius of wrist pin 162 and θ is the angle of offset.

The angle of offset equation is an equation pursuant to which the angle of offset 112 is proportional to the distance between wrist pin center point 122 and big end bearing center point 132, and is a calculation which determines the angle sufficient to create an offset line of action 104 which creates an offset torque force resulting in increased efficiency.

The angle of offset equation is as follows:

θ=arcsine(r/L)

In this equation, L is defined as the distance between the center point of the wrist pin aperture 122 and the center point of the big end bearing aperture 132. r is defined as the measure of the radius of the big end bearing aperture 134. θ is defined as the calculated angle of offset. It is critical that angle of offset 112 is greater than 0 and less than 45 degrees. However, in most exemplary embodiments, angle of offset 112 is less than 30 degrees.

Because the angle of offset is critically limited to greater than 0 degrees and less than 45 degrees, the area of force transfer area 118 is limited for a given wrist pin radius. Most wrist pins have a radius of 6 inches or less. For most standard cars, wrist pins have a radius of 1.5 inches or less. However, the exact radius for a wrist pin will vary depending on the vehicle, motor and piston size.

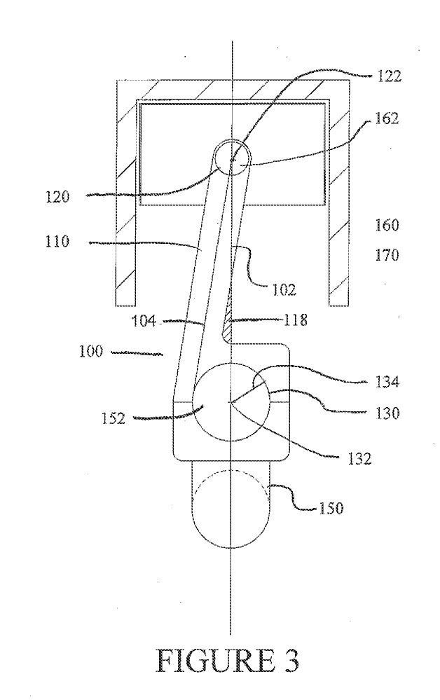

FIG. 3 is a side perspective view of an exemplary embodiment of offset connecting rod 100 as fitted within an internal combustion engine, which also shows offset line of action 104. The embodiment shown in FIG. 3 is adaptable to an internal combustion engine using a method of manufacture employing the angle of offset equation and force transfer area equation defined herein. A traditional connecting rod may simply be removed from internal combustion engine and replaced with offset connecting rod 100 with no mechanical adaptation to accommodate offset connecting rod 100.

Offset connecting rod 100 illustrated in FIG. 3 is shown at top dead center location within cylinder 170 with piston 160 at the top of cylinder 170. At this position, it is critical that angle of offset 112 be large enough to create a force transfer area 118 of greater than 0 when calculated using the force transfer area equation. It is critical that angle of offset 112 be greater than zero degrees and less than 45 degrees.

The resulting force transfer area creates a complete discontinuity or gap in material along traditional line of action 102. It is critical that a complete discontinuity in material occur along traditional line of action 102 so that force transferred along connecting rod 100 is completely offset.

Without the criticality of force transfer area 118 creating a physical discontinuity in material of offset connecting rod 100 along the traditional line of action 102, force will not be completely offset.

While the connecting rod has been shown and described with respect to an illustrative embodiment and used in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A method of manufacture of highly efficient universal connecting rod comprising the steps of:
a. constructing an connecting rod having an offset longitudinal axis, a line of action offset from a traditional line of action, an elongated rod body parallel with said line of action, a first circular aperture and a second circular aperture;
b. constructing said first circular aperture used for pivotally attaching said connecting rod to a wrist pin, and said first circular aperture having a center, and a radius;
c. constructing said second circular aperture used to pivotally attach said connecting rod to a big end bearing;
d. constructing said second circular aperture having a center, and a radius; and
e. constructing a triangular force transfer area comprised of an area free of any solid material and defined by said traditional line of action on a first side and said connecting rod on a second and third side such that said elongated rod body is discontinuous along said traditional line of action causing, wherein said force transfer area is calculated as (½)((0.1)(w))(((0.1)(w))(cotθ)) wherein w is the radius of said first circular aperture and θ is an angle of offset being greater than 0 degrees and less than 45 degrees and calculated as θ=arcsine(r/L) wherein r is the radius of said second circular aperture and L is a distance between a center point of said first circular aperture and a center point of said second circular aperture.

2. The method of manufacture of claim 1 wherein said force transfer area is created by removing material from said elongated rod body.

3. The method of manufacture of claim 1 wherein said angle of offset is greater than 0 degrees and less than 30 degrees.

4. The method of manufacture of claim 1 wherein said radius of said wrist pin is less than 6 inches.

5. The method of manufacture of claim 1 wherein said radius of said wrist pin is less than 1.5 inches.

6. The method of manufacture of claim 1, wherein said angle of offset is a critical ratio of said radius of said big end bearing connected by said second circular aperture to the said distance between the center point of said first circular aperture and said center point of said second circular aperture.

7. The method of manufacture of claim 1, wherein said longitudinal axis forms said angle of offset as determined by said angle of offset equation.

8. The method of manufacture of claim 1, made from a process selected from the group consisting of molding, milling, tooling, machining, forging, extruding, sintering, rapid prototyping, stamping, assembling, remanufacturing and welding.

9. The method of manufacture of claim 1, wherein said offset longitudinal axis includes said force transfer area formed by a process selected from the group consisting of molding, milling, tooling, machining, forging, extruding, sintering, rapid prototyping, stamping, assembling, remanufacturing and welding.

10. The method of manufacture of claim 1, wherein said offset longitudinal axis, said first circular aperture and said second circular aperture are proportional to specifications of a specified connecting rod so that said universal connecting rod may be used to replace said specified connecting rod.

11. The method of manufacture of claim 1, wherein said longitudinal axis, said first circular aperture and said second circular aperture are proportional to specifications of a commercially available connecting rod so that said universal connecting rod may be used to replace said commercially available connecting rod.

12. The method of manufacture of claim 1, made from a material selected from the group consisting of steel, aluminum, ceramic, plastic and metal alloy.

13. A method of manufacture of a highly efficient universal connecting rod comprising the steps of:
a. calculating a triangular force transfer area comprised of an area free from any solid material and bordered on a first side by a traditional line of action and by said connecting rod on a second and third side, wherein said force transfer area is calculated as (½)((0.1)(w))(((0.1)(w))(cotθ)) wherein w is the radius of a first circular aperture in said connecting rod and θ is an angle of offset having a value greater than 0 degrees and less than 45 degrees and calculated as θ=arcsine(r/L) wherein r is the radius of a second circular aperture in said connecting rod and L is a distance between a center point of said first circular aperture and a center point of said second circular aperture; and
b. forming an offset connecting rod having said angle of offset which creates said calculated force transfer area.

14. The method of claim 13, further including the step of calculating a force transfer angle a critical ratio of a radius of a big end bearing connected by said second circular aperture to the distance between the center point of said first circular aperture and said center point of said second circular aperture.

15. The method of claim 13, further including the step of calculating a force transfer angle such that an offset longitudinal axis contains a force transfer area as determined by said force transfer area equation.

16. The method of claim 13, further including the step of forming the universal connecting rod by a process selected from the group consisting of molding, milling, tooling, machining, forging, extruding, sintering, rapid prototyping, stamping, assembling, remanufacturing and welding.

17. The method of claim 13, further including the step of forming the universal connecting rod proportional to specifications of a commercially available connecting rod so that said universal connecting rod may be used to replace said commercially available connecting rod.

18. The method of claim 13, further including the step of forming the universal connecting rod from a material selected from the group consisting of steel, aluminum, ceramic, plastic and metal alloy.

19. A method of manufacture of a highly efficient universal connecting rod comprising the steps of:
a. calculating an angle of offset using an angle of offset equation calculated as θ=arcsine(r/L) wherein r is a radius of a circular aperture in said connecting rod and L is a distance between a center point of a first circular aperture and a center point of said second circular aperture, wherein said angle of offset is greater than 0 degrees and less than 45 degrees; and
b. forming an connecting rod having said angle of offset to create a force transfer area, wherein said force transfer area is a triangular area free from any solid material and bordered by a traditional line of action on a first side and by said connecting rod on a second a third side.

20. A method of manufacture of a universal offset connecting rod comprising the steps of:
a. calculating an angle of offset of greater than 0 degrees and less than 45 degrees using an angle of offset equation pursuant to which the angle of offset is proportional to the distance between a center point of a first circular aperture for connecting a wrist pin and a center point of a second circular aperture for connecting a big end bearing; and
b. forming an offset connecting rod having said angle of offset to create a force transfer area, wherein said force transfer area is a triangular area free from any solid material and bordered by a traditional line of action on a first side and by said connecting rod on a second a third side.
